(19) United States
(12) Patent Application Publication
(10) Pub. No.: US 2005/0188911 A1
(43) Pub. Date: Sep. 1, 2005

(54) Torque indicator

(75) Inventor: Scott G. Manke, Sun Prairie, WI (US)

Correspondence Address: FOLEY & LARDNER, 777 EAST WISCONSIN AVENUE, SUITE 3800, MILWAUKEE, WI, 53202-5308, US

(73) Assignee: Masterchem Industries, Inc.

(21) Appl. No.: 10/790,422

(22) Filed: Mar. 1, 2004

(51) Int. Cl. B65D 41/04; B65B 7/28; G09F 9/00

(52) U.S. Cl. 116/307; 215/230; 215/329; 220/288

(57) ABSTRACT

A torque indicator comprising a range indicator on a container. A visual indicator on a cap of the container, wherein as the cap is attached to the container, the visual indicator position relative to the range indicator shows extent of cap engagement with the container. The visual indicator and the range indicator may be molded on the container or may be a decal, stickers or label.

### FIELD AND BACKGROUND OF THE INVENTION

The present invention relates generally to the field of a container cap for sealing a container, and more particularly to a torque indicator associated with a cap for the container.

It is generally known to provide a container for fluids, for example, paint. Such known containers are typically cylindrical metal containers with a cylindrical lid. The lid of such known containers fits into a cylindrical shape “chime” or rim having a u-shaped channel that frictionally receives and engages the lid. However, built-up, dried material, such as paint, in the channel formed during use may prevent a lid from being fully sealed within the channel, which may cause the leakage of the fluid in the container.

It is also generally known to provide a plastic container for fluids, for example, paint. Such known plastic containers typically have a lid that screws onto a thread of the container. However, such known plastic containers may not form as tight a seal between the container and the lid as do such known metal containers. In such known plastic containers a seal is typically formed by providing a separate gasket placed in the lid to affect the seal. Other methods provide various nubs or projections formed in the lid to affect a seal of the container. Such methods may not form effective seals if the separate gasket is lost or broken or if the projection or nub becomes worn or breaks off during use.

An additional problem with the screw-on lid is a user does not know how tight the lid is turned onto the container. As a result, the threads can become worn, over tightening can cause the threads to disengage, and insufficient tightening can result in no seal being formed with the container.

Thus, there is a need to indicate how tight a lid is fastened to a container to affect a seal. There is a further need for a method to indicate when sufficient torque has been applied to a container cap to form a seal. It would still further be desirable to provide a container system and method having one or more of these or other advantageous features.

### SUMMARY OF THE INVENTION

There is provided a torque indicator comprising a range indicator on a container. A visual indicator on a cap of the container, wherein as the cap is attached to the container, the visual indicator position relative to the range indicator shows extent of cap engagement with the container. The visual indicator and the range indicator may be molded on the container or may be a decal.

There is further provided a method for indicating the extent of engagement of a container cap on a container, with the container cap and container having corresponding intermeshing threads. The method comprises the steps of providing a range indicator on the container. Configuring the range indicator to represent the extent of engagement of the cap to the container. Providing a visual indicator on the cap and aligning the visual indicator in indicative proximity to the range indicator.

### BRIEF DESCRIPTION OF THE DRAWINGS

FIG. 1 is a top plan view of an exemplary embodiment of a container cap on a container.

FIG. 2 is a sectional view of the container cap and container illustrated in FIG. 1 along the line 2-2.

FIG. 3 is a top plan view of an exemplary embodiment of a container cap.

FIG. 4 is a sectional view of the container cap illustrated in FIG. 3 along the line 4-4.

FIG. 5 is a bottom plan view of the container cap illustrated in FIG. 3.

FIG. 6 is a perspective bottom view of an exemplary embodiment of a container cap.

FIG. 7 is a perspective top view of an exemplary embodiment of the container cap illustrated in FIG. 6.

### DETAILED DESCRIPTION OF EXEMPLARY EMBODIMENTS

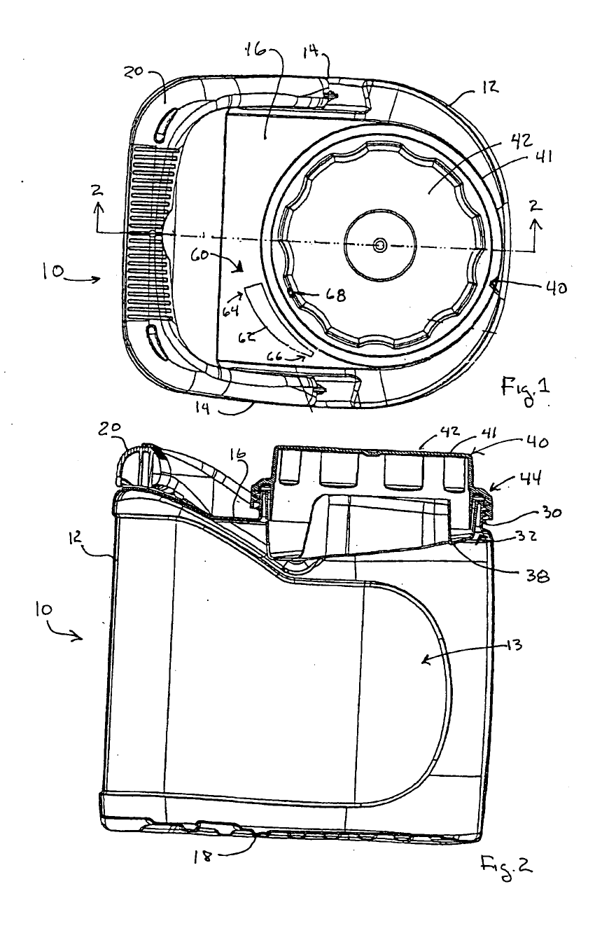

Referring to FIGS. 1 and 2, a container 10 for containing fluid and a cap 40 are illustrated. FIG. 1 also illustrates an exemplary embodiment of a torque indicator 60. Container 10 includes a body 12 formed by vertical sidewall 14 extending between the horizontal top portion 16 and a horizontal base 18 defining an interior space 13 to hold a fluid. A bail or handle 20 is attached to container 10 by a locking system or mechanism. A cover (shown as a cap or lid 40) having threads 46 is attached to threads 34 of a neck 30 of body 12 (see FIG. 2 and FIG. 4). A selectively removable pour spout (fitment) 38 is interference or snap fit within neck 30 as shown in FIG. 1 for controlled pouring of a fluid, such as paint for example, from container 10.

A primary seal is formed by engagement of threads 46 of lid 40 with threads 34 of neck 30. An interference fit between the lid 40 and the neck 30 is accomplished by rotating or twisting the lid 40 onto neck 30 a predetermined distance. Such seal is intended to inhibit fluid from leaking from the container 10 when the lid 40 is fixed to the neck 30. An additional seal is formed by a resilient gasket 50 which is integrally formed with the lid 40 to complete the seal between the lid 40 and the neck 30 of the container 10.

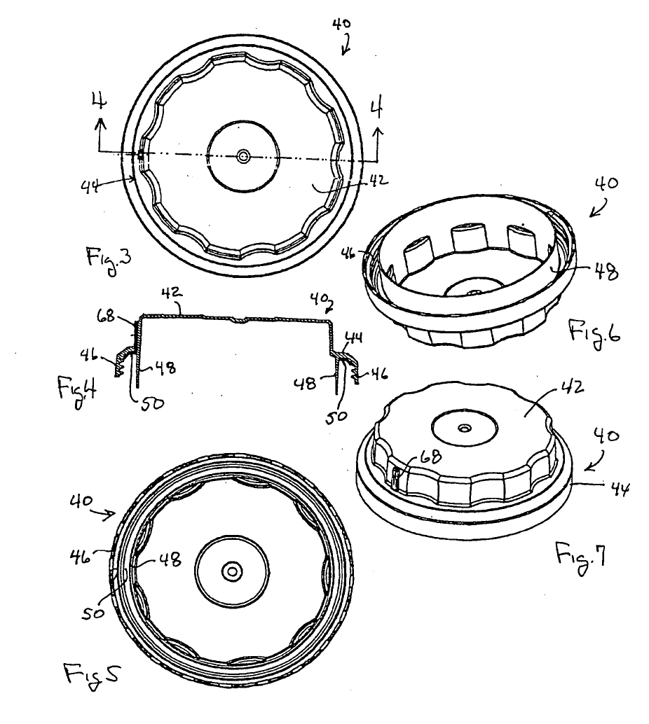

Referring to FIGS. 3-7, a container cap 40 serves both as a lid and a cup for material held in the container, for example, paint. The container cap 40 includes a top surface 42 and a downwardly extending wall 44, portions of which extend from the top 42 of the cap 40 between the fitment 38 and the neck 30 of the container 10. The container cap 40 also includes an internal threaded portion 46 that threadably engages threads 34 formed on the neck 30 of the container 10 and an unthreaded portion 48 a space distance from the threaded portion 46. The container cap 40 can be configured to receive a molded logo, a clear window to see the interior 13 of the container 10, or other indicia to identify the contents of the container 10.

The container cap 40 may be formed by two or more materials, for example a rubber based, thermal plastic elastomer, polypropylene, polyvinyl chlorides, thermal plastic polyurethanes and combinations of such material, or other type of plastic or elastomer using a two-shot or bi-injection molding process.

The wall 44 of the container cap 40 is formed of a rigid material such as a polypropylene copolymer. A resilient gasket 50 is integrally formed between the threaded portion 46 and the unthreaded portion 48 of the wall 44 of the container cap 40. The formation of the resilient gasket 50 occurs during the second shot of the two-shot injection molding process.

The container cap 40 can be configured to provide a portion of a second material to extend into recesses formed on the outer periphery of the cap 40, which may assist the user in gripping and manipulating the cap 40 on and off the container 10. Various textures may be molded into the second material and different colors of the material may be employed during the molding process.

In order to assist the user of the container 10 during the sealing of the container 10 with the container cap 40, a torque indicator 60 is provided on the container 10. A convenient location for the torque indicator 60 is on the top side or horizontal top portion 16 of the container 10 as shown in FIG. 1. It should be understood that other convenient locations for the torque indicator can be used.

The torque indicator 60 includes a range indicator 62 and a visual indicator 68. The range indicator 62 can be molded on the container 10 or it can be a decal such as a sticker, or label or printing, affixed to the container 10 by any convenient manner. The visual indicator 68 can be molded on the cap 40.

An exemplary embodiment of the torque indicator 60 provides that the range indicator 62 is configured to represent the extent of engagement of the cap 40 to the container 10. The visual indicator 68 is aligned with the range indicator 62 in indicative proximity to the range indicator 62. For purposes of this application “indicative proximity” means that the visual indicator 68 is positioned adjacent to the range indicator 62 to indicate the extent of engagement of the cap 40 to the container 10 as the cap 40 is turned on the corresponding intermeshing threads of the cap 40 and the neck 30 of the container 10. Range indicator 61 and visual indicator 68 are positioned relative to threads 34 and 46 respectively such that visual indicator 68 is located proximate the range indicator 62 when an adequate seal is formed between cap 40 and container 10.

In the illustrated embodiments, the visual indicator 68 is molded on the cap 40 during the second shot of the two-shot injection molding process described above. The range indicator 62 can be elongated having a first end 64 and a second end 66. One exemplary embodiment of the range indicator 62 provides that the second end 66 is narrower than the first end 64 as illustrated in FIG. 1. Such range indicator 62 reflects more torque is applied to the cap 40 as the cap is rotated in a clockwise direction to tighten the cap 40 to form the seal on the container 10. An operator can observe the visual indicator 68 move alongside the range indicator 62 and stop tightening the cap 40 when the visual indicator 68 position relative to the range indicator 62 showed the extent of cap engagement with the container 10 as being properly tightened or torqued down.

Further modifications may be made to the design, arrangement and combination of the elements without departing from the scope of the invention. For example, a top member including one or more of the features discussed above such as the spout and others may be integrally formed with the body of the container or may be fastened to the container as a separate component. Additionally, the container may include transparent areas to allow the user to see the contents of the container. Further, the container cap may include a transparent area to indicate whether the cap is securely attached to the container to prevent paint from accidentally being spilled. Although the container has been referred to as a paint container, other liquids may be stored and poured as well. Some of the features have a unique application to the storage and application of paint, other features may be used for other liquids as well. Additionally, a label that is applied to the container may include a blank white portion to permit the user of manufacturer to dab or paint a sample of the paint in the container to clearly show what color is contained within the container and how it will appear when painted on a white background. It is also noted that the features described in this specification and shown in the figures either alone or in combination may also be combined with individual or multiple features disclosed herein. These and other modifications may be made in the design, arrangement, and combination of the elements without departing from the scope of the invention as expressed in the appended claims.

1. A torque indicator on a container having a cap, the torque indicator comprising:
a range indicator on the container;
a visual indicator on the cap of the container,
wherein as the cap is attached to the container, the visual indicator position relative to the range indicator show extent of cap engagement with the container.

2. The torque indicator of claim 1, wherein the visual indicator is molded on the cap.

3. The torque indicator of claim 1, wherein the range indicator is molded on the container.

4. The torque indicator of claim 1, wherein the range indicator is one of a decal, sticker, label and printing.

5. The torque indicator of claim 1, wherein the range indicator is elongated and has a first end and a second end.

6. The torque indicator of claim 5, wherein the second end is narrower than the first end.

7. A method for indicating extent of engagement of a container cap on a container, with the container cap and container having corresponding intermeshing threads, the method comprising the steps of:
providing a range indicator on the container;
configuring the range indicator to represent the extent of engagement of the cap to the container;
providing a visual indicator on the cap; and
aligning the visual indicator in indicative proximity to the range indicator.

8. The method of claim 7, wherein the range indicator is one of a molded portion, a decal, a sticker, a label and a printing

9. The method of claim 8, wherein the range indicator includes one end that is narrower than another end.
